(19) United States
(12) Patent Application Publication
(10) Pub. No.: US 2025/0265645 A1
(43) Pub. Date: Aug. 21, 2025

(54) SYSTEMS AND METHODS FOR ENHANCED OPERATION CONTINUITY IN DECENTRALIZED EXCHANGE NETWORKS

(71) Applicant: BANK OF AMERICA CORPORATION, Charlotte, NC (US)

(72) Inventors: George Anthony Albero, Charlotte, NC (US); Sanjay Arjun Lohar, Charlotte, NC (US); James J. Siekman, Charlotte, NC (US); Naga Vamsi Krishna Akkapeddi, Charlotte, NC (US); Elijah John Clark, Charlotte, NC (US)

(73) Assignee: BANK OF AMERICA CORPORATION, Charlotte, NC (US)

(21) Appl. No.: 18/581,828

(22) Filed: Feb. 20, 2024

(51) Int. Cl. G06Q 40/04

(52) U.S. Cl. CPC G06Q 40/04

(57) ABSTRACT

Systems, computer program products, and methods are described herein for operation continuity in decentralized exchange networks. The present disclosure is configured to monitor transaction requests, detect and respond to disruptions by rerouting transactions through alternative paths, and interface with a decentralized marketplace to ensure uninterrupted processing. Utilizing smart contract protocols for automated bidding, the system optimizes transaction flow, enhances user experience through real-time updates, and provides third parties with market insights derived from aggregated transaction data. This technology represents a advancement in transaction technology, offering a resilient and efficient alternative to traditional transaction processing systems.

### TECHNOLOGICAL FIELD

Example embodiments of the present disclosure relate to enhanced operation continuity in decentralized exchange networks.

### BACKGROUND

In the realm of decentralized exchange networks, ensuring the continuity and success of transactions across multiple systems, especially in scenarios where a system becomes unavailable or credentials are expired or disabled, poses significant challenges. Traditional systems often struggle to provide seamless operation under such conditions, leading to potential delays, increased costs, and compromised transaction integrity. These challenges are particularly acute in financial transactions, where the timely and secure processing of operations is critical.

Applicant has identified a number of deficiencies and problems associated with enhanced operation continuity in decentralized exchange networks. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for enhanced operation continuity in decentralized exchange networks. The disclosed system introduces a facilitator system designed to ensure the continuity of operations across decentralized exchange networks. This system acts as an intermediary, capable of authenticating users and assessing the availability of provider systems. In the event of a system unavailability or a failure in communication, the facilitator system dynamically routes transactions through alternative pathways, based on a set of criteria including transaction type, security rating, and other relevant attributes. This ensures that transactions can be completed even when the originally intended system is not available. Furthermore, the facilitator system can interface with a decentralized marketplace, allowing institutions and possibly other participants to bid for or accept transaction requests based on predefined rules and commission structures. This approach not only addresses the identified deficiencies in ensuring operation continuity but also introduces a novel mechanism for transaction processing in decentralized environments.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for enhanced operation continuity in decentralized exchange networks, in accordance with an embodiment of the disclosure;

FIG. 2 illustrates a background pathway process flow with multiple event instances, in accordance with an embodiment of the disclosure;

FIG. 3 illustrates a process flow for facilitating enhanced operation continuity in decentralized exchange networks, in accordance with an embodiment of the disclosure;

FIG. 4 illustrates a process flow for enhanced operation continuity via use of alternate pathways and decentralized exchange networks, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application.

The disclosed technology pertains to the field of financial technology and specifically addresses the automation and optimization of transaction processing within decentralized exchange networks. The technology integrates advanced computational methods and machine learning algorithms to enhance the efficiency and security of financial transactions across a distributed ledger system. The problem in the field arises from the need to ensure continuous operation and transaction integrity within decentralized networks, particularly when disruptions occur, such as system downtimes or credential validation issues. Traditional systems often fail to provide a seamless transition during such events, leading to delayed transactions and potential loss of trust from consumers and financial institutions alike.

The solution is akin to a highly intelligent traffic management system for financial transactions. The technology detects problems in the transaction network and quickly finds alternative paths to keep the transaction moving towards its destination without delay. It uses real-time data and a network of alternative routes to prevent bottlenecks and ensure a smooth flow of financial operations. Accordingly, the present disclosure offers a multi-faceted approach to maintaining transaction flow within decentralized financial networks. This is achieved through a real-time monitoring and rerouting system that leverages a decentralized marketplace for transaction processing. This system ensures that transactions are not stalled by local disruptions, providing a resilient and efficient alternative to traditional centralized processing.

What is more, the present disclosure provides a technical solution to a technical problem. As described herein, the technical problem includes the inability of existing systems to maintain continuous transaction processing in the face of various network and system disruptions. The technical solution presented herein allows for the automatic rerouting of financial transactions using a facilitator system that employs smart algorithms to assess and navigate around these disruptions. In particular, the solution is an improvement over existing solutions to the problem by (i) reducing the transaction processing steps, thus conserving computational resources, (ii) enhancing the accuracy of transaction routing, minimizing the need for additional resources to correct errors, (iii) automating the rerouting process, which eliminates manual intervention and increases the efficiency of the network, (iv) optimizing resource allocation, thereby decreasing network congestion and reducing the load on the computational infrastructure. Furthermore, the technical solution described herein uses a rigorous, computerized process to execute transaction rerouting, a task that was previously not performed automatically. In specific implementations, the technical solution bypasses a series of steps previously necessary for manual intervention, thus further conserving computing resources and enhancing the overall performance of the transaction processing system.

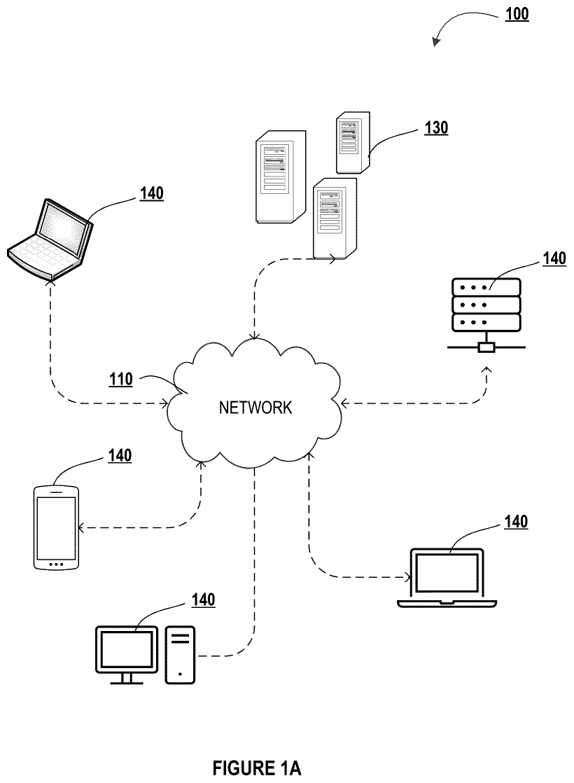

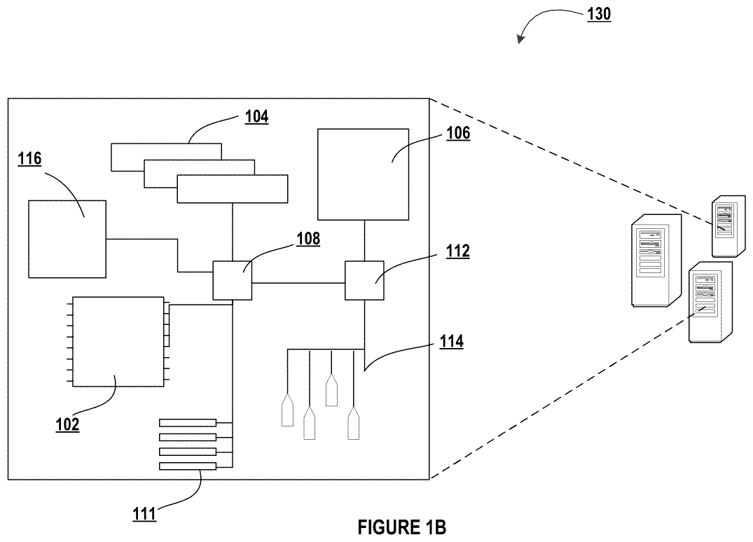

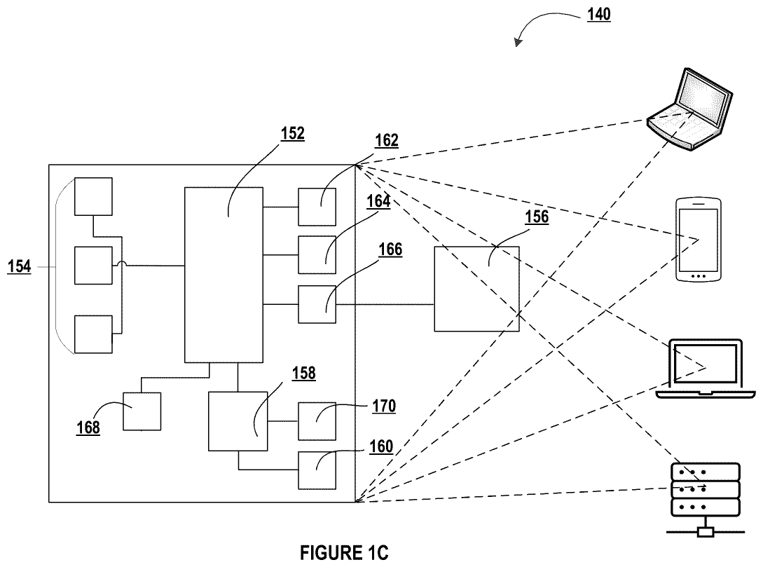

FIGS. 1A-1C illustrate technical components of an exemplary distributed computing environment 100 for enhanced operation continuity in decentralized exchange networks, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer—or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

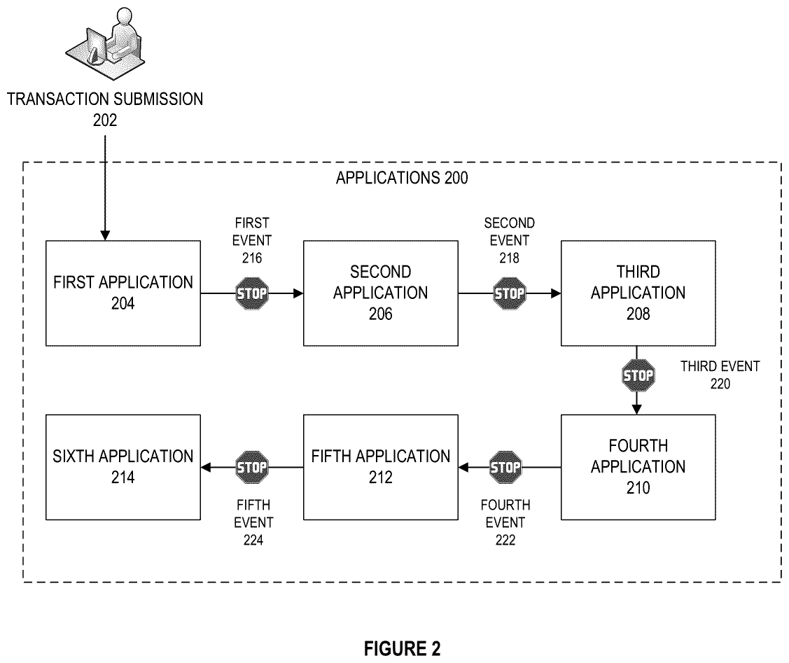

FIG. 2 illustrates a background pathway process flow with multiple event instances, in accordance with an embodiment of the disclosure. The flowchart depicts a transaction submission 202 leading through a sequence of applications, each linked by specific events provided for example purposes. The process initiates with the transaction submission 202, which represents the entry point for a transaction request from a user or an automated agent, or the like. This component is the trigger that sets the subsequent flow in motion, where the transaction is submitted to the first application in the pathway. The submission point is crucial as it captures the transaction details, including the intended recipient application and the transaction parameters such as value, type, urgency, and details and allow the system to generate security rating. Upon submission, the transaction reaches the first application 204, which acts as the primary processing node. In some embodiments, the first application 204 assesses the transaction against predefined criteria and protocols. If the first application 204 is fully operational, it will process the transaction accordingly. However, in the event of a system issue, disruption, or stoppage requirement, such as downtime or maintenance, as indicated in FIG. 2 as first event 216, the transaction may be rerouted to the second application 206 to ensure continuity of operation. As shown, in some embodiments, the second application 206 is the secondary node in the process flow, available to continue transaction processing if the first application 204 fails to process the transaction. The shift from the first application 204 to the second application 206 is governed by the first event 216, which is an automated response to issues like network disruptions or system outages. Similarly, the second event 218 triggers a shift to the third application 208 if the second application 206 encounters a stoppage or delay, ensuring the transaction continues.

Further down the flow, the third application 208, fourth application 210, fifth application 212, and sixth application 214 are illustrated as additional nodes that the transaction may be passed to in the case of subsequent events such as the third event 220 and fourth event 222, which may include system maintenance or principal propagation issues, or the like. Each application node is a potential processing point that can independently authenticate and handle the transaction, with the capability to pass it along to the next node if it cannot proceed due to a disruption. The fifth event 224 is the final illustrated contingency that leads the transaction from the sixth application 214 back to the fifth application 212, completing a process flow designed to mitigate any single point of failure due to a disruption within the network.

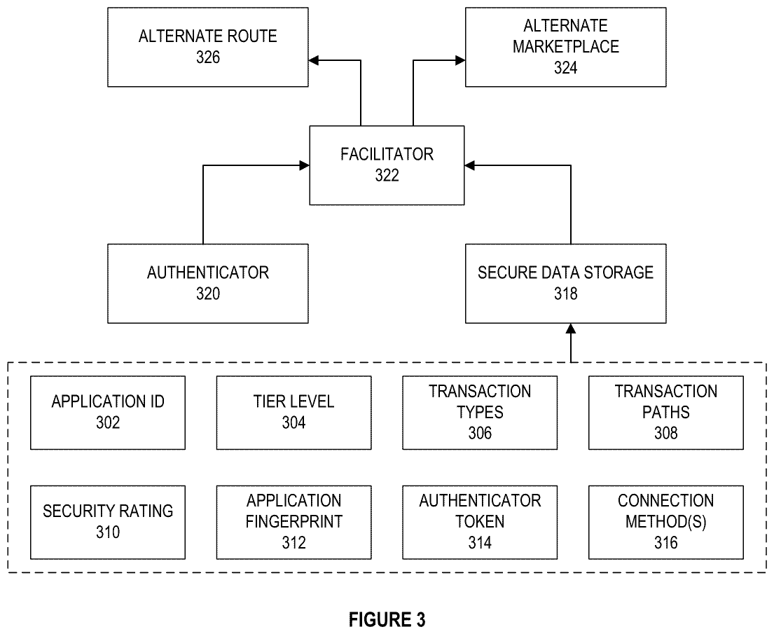

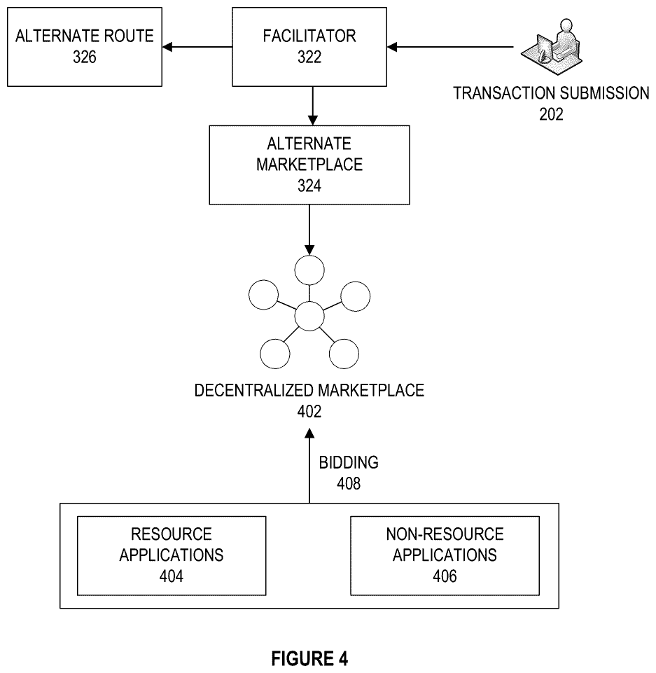

As one of ordinary skill in the art will appreciate, the flow of FIG. 2 underscores the reality of the issue with conventional approaches to transaction processing, acknowledging the numerous points at which the transaction may be interrupted. The depicted process flow considers the various disruptions that could arise in various embodiments, such as system downtime, expired or disabled credentials, or even a lapse in a necessary principal propagation. By preparing for these eventualities, the proposed system ensures that each transaction is guaranteed to bypass this myriad of potential faults. Furthermore, as one of ordinary skill will further appreciate, when transactions are required to be transmitted between disparate systems, it is possible that one of the systems may be non-functional for various reasons. In other embodiments, user credentials or service credentials may be expired, disabled, or otherwise no longer serviceable, or there may be system memory issues or network outages, or the like. As such, FIG. 2 not only underscores that alternate transaction routing is necessary, but also must be integral to the proposed network architecture. As further illustrated in FIG. 3, the proposed solution seamlessly executes an auto-mitigation of transaction flow, ensuring the continuity of operations and the security of application processing within the network. In addition, as illustrated in FIG. 4, the proposed solution also offers a completely alternate processing option via a decentralized bidding process.

FIG. 3 illustrates a process flow for facilitating enhanced operation continuity in decentralized exchange networks, in accordance with an embodiment of the disclosure. The diagram details an architecture comprising multiple components that interact to maintain transaction integrity across varied cloud-based integration services, encompassing both hardware and software realms to establish a seamless transactional environment.

At the center of the system lies the facilitator 322, a central hub that orchestrates the routing of transaction requests. This facilitator 322 is engineered to be system-agnostic, capable of interfacing with a multitude of provider systems such as financial institutions, and a spectrum of subscribers, from individual users to comprehensive user applications. The integration is achieved through a multifaceted registration process that captures essential attributes like the application ID 302 and tier level 304, which demarcate each application's identity and processing hierarchy within the network. The facilitator 322 is configured to store a detailed catalog of transaction types 306 each application is capable of handling, along with designated transaction paths 308.

It is understood that facilitator 322 includes a catalogue comprising broad spectrum of transaction types 306 that each application within the network is equipped to manage. For instance, it can seamlessly facilitate straightforward card payments, where speed and efficiency are paramount, and route these through optimized transaction paths 308 designed for high-volume, low-latency processing. On the more complex end of the spectrum, the system is equally adept at handling loan origination processes, which require a series of checks and balances, such as credit assessments and compliance verifications. These transaction types are routed through pathways that can support enhanced security measures and integrate with various financial analysis tools.

Additionally, the facilitator system is programmed to recognize and process transaction types including but not limited to equity trades, which may necessitate real-time market data feeds and rapid execution channels, or international remittances that involve currency exchange and cross-border regulations. It also caters to more nuanced transaction types such as recurring subscription payments, where it schedules and executes transactions based on time-sensitive agreements, and peer-to-peer transfers that demand immediate yet secure processing protocols, or the like.

Each transaction type 306 is linked to one or more transaction paths 308, which are defined not only by the technical requirements of the transaction itself but also by the operational status of the network nodes. This ensures that every transaction, regardless of its nature or complexity, is processed in a manner that upholds the integrity, security, and expedience required by the user and the underlying system specifications. It is understood that the facilitator 322, in some embodiments, evaluates transactions using an algorithm that factors in the security rating 310, a metric determined by the system's tier level that the transaction will traverse. It is understood that in some embodiments the algorithm could be a weighted scoring system that assigns values to various aspects of a transaction to compute the security rating 310. For example, the algorithm may assign a higher weight to transactions involving larger sums or those designated as high priority due to their time sensitivity. In some embodiments, the algorithm factors in the historical success of the application based on the application fingerprint 312, which includes past performance metrics such as uptime and response rate.

It is understood that, in some embodiments, the tier level 304 also plays a crucial role in the algorithm calculations. Higher-tier systems, which are typically more robust and have greater processing capabilities, might be assigned lower scores, reflecting their increased success rate. Conversely, lower-tier systems might contribute to a higher security rating for a transaction due to their reduced capacity or historical performance issues. The authenticator token 314, which could be an OAuth token, provides a security checkpoint in the transaction process. In some embodiments, the algorithm checks the validity of this token against a database of authorized tokens. A valid token might lower the transaction's security rating, indicating a lower security concern, whereas an invalid token could raise the security rating, prompting the facilitator 322 to either reject the transaction or route it through additional security checks. In further embodiments, the algorithm may incorporate machine learning techniques to continuously refine its weighting system based on new data, adapting to emerging patterns in transaction security and system performance. This would allow the facilitator 322 to dynamically adjust its evaluation criteria, ensuring that the security rating 310 remains a robust and up-to-date reflection of the transaction security rating.

It is understood that the application fingerprint 312, a digital identifier, and the authenticator token 314, such as OAuth, are employed to establish a fortified authentication mechanism. The robustness of the system is further bolstered by secure data storage 318, which employs encryption and redundancy to safeguard registration details and transaction logs. The versatility of facilitator 322 in communication is showcased by its ability to leverage one or more connection method(s) 316, encompassing REST, SOAP, JDBC, JMS, and native cloud service protocols, thus ensuring compatibility and responsiveness with various provider system APIs (application programming interfaces) and communication frameworks.

The facilitator employs a variety of communication methods to ensure it can interface effectively with different provider systems. These methods include REST (Representational State Transfer), SOAP (Simple Object Access Protocol), JDBC (Java Database Connectivity), and JMS (Java Message Service), each catering to different integration needs and protocols within the network. REST is used for its stateless architecture and is widely adopted for web services. SOAP is a protocol for exchanging structured information in the implementation of web services in computer networks. JDBC is an API for the Java programming language that defines how a client may access a database. JMS is a messaging standard that allows application components based on the Java Enterprise Edition (Java EE) to create, send, receive, and read messages.

Upon initiation of a transaction, the facilitator 322 engages in a handshake with the provider system using the connection method 316. If this initial communication attempt fails, the facilitator 322, drawing upon an analysis of transaction type 306 and security rating 310, activates a contingency protocol. This protocol may redirect the transaction through an alternate route 326, a dynamically determined pathway that circumvents the failure point, ensuring the transaction's delivery to the intended destination. However, in some embodiments, the alternate route 326 may not be available due to one or more disruptions, as discussed with regard to FIG. 2.

As such, in cases of disruption, the system's adaptability is further exemplified in scenarios where the facilitator system engages an alternate marketplace 324. This digital forum allows for the decentralization of transaction validation, where financial and possibly non-financial entities can participate in the transaction process, introducing a competitive landscape governed by market dynamics and regulated by commission structures reflective of the transaction complexity and security rating 310. Through this matrix of components, the facilitator 322 ensures not just the verification and routing of transactions but also their resilience against disruptions. This is achieved through a combination of hardware-level redundancies, software-level failovers, and coding practices that promote dynamic rerouting and load balancing. The result is a network that maintains operation continuity, capable of real-time adaptation to a spectrum of potential network and system availability changes, thus providing a sturdy framework for transaction handling in decentralized exchange networks.

FIG. 4 illustrates a process flow for enhanced operation continuity via use of alternate pathways and decentralized exchange networks, in accordance with an embodiment of the disclosure. Again, at the core of this process flow is the facilitator 322, which acts as a central node that interfaces with various components of the system to ensure smooth transaction processing. As discussed with respect to FIG. 2, transaction submission 202 is the inception point of the process, where a user or an automated system initiates a transaction. This submission acts as a trigger for the facilitator 322 to begin its coordinating role. The facilitator 322, equipped with routing algorithms, assesses the best course of action for the transaction. In the case of disruptions or inefficiencies detected along the primary route, the facilitator 322 has the capability to divert the transaction through an alternate route 326. This rerouting is done in real-time and is transparent to the user, ensuring that there is no interruption in service. The transaction typically follows a predefined path through a network of interconnected applications. As the transaction progresses along its original route, the system continuously monitors for any disruptions or inefficiencies. If an application within the original path encounters an issue, such as a system down or a principal propagation problem, the facilitator 322 is immediately alerted.

Upon detecting such a disruption, the facilitator 322 activates an alternate routing protocol. It dynamically assesses the network to identify an alternative path, ensuring that the transaction can bypass the compromised node. For instance, if a third application in the original path is down, the facilitator 322 may reroute the transaction from a second application to a fourth application, circumventing the failure point. Similarly, if there is a principal propagation issue at a sixth application, the transaction is rerouted from a fifth application to an alternative application that can take over the processing, which, in some embodiments, may include routing back to a sixth application which is now functioning correctly in the alternate pathway. This rerouting process is accomplished in real-time, with sophisticated algorithms determining the next best route based on current network conditions and the priority of the transaction. The selection of an alternate route 326 is made with consideration to maintaining the integrity and timeliness of the transaction.

The facilitator 322 decision-making process for rerouting is informed by a variety of factors, including the urgency of the transaction, the capacity and current load of alternative paths, and the security requirements. It ensures that the alternate route is capable of handling the transaction without any loss of service quality. The facilitator's integration with the decentralized marketplace allows it to leverage a broader network of resources. If the internal network alternate routes are not viable, the facilitator 322 can refer the transaction or post the transaction into the decentralized marketplace, where various resource applications and non-resource applications are available to bid for and process the transaction. This bidding process is managed by the facilitator, which selects the best bid based on criteria like cost, speed, trust score, or the like.

Throughout this process, in some embodiments, the user remains unaware of the underlying complexities. The transition from the original route to an alternate route is seamless, with no interruption in service perceived by the end user. The facilitator 322 ensures that the transaction reaches its intended destination efficiently, regardless of the challenges encountered. As such, the alternate marketplace 324 plays a pivotal role in providing additional transaction pathways. It operates as a platform where different financial entities can offer their services to take over the transaction processing at a published, decentralized market rate. This marketplace is characterized by its decentralized nature, allowing for a competitive environment where transactions can be processed by the entity offering the most favorable terms or which possesses the necessary bandwidth and processing capability for the transaction based on its characteristics.

Central to the decentralized exchange network is the decentralized marketplace 402, which connects multiple resource applications 404 and non-resource applications 406. The resource applications 404 are typically robust, high-capacity systems capable of handling large volumes of transactions or those requiring significant computational power. On the other hand, non-resource applications 406 are often used for less demanding tasks but are crucial for the diversification and resilience of the network. The bidding process 408 represents a dynamic mechanism within the decentralized marketplace 402. It allows for real-time negotiation and allocation of transaction processing based on various factors such as transaction size, complexity, required speed of processing, and the current load on the network. This process ensures that transactions are not only processed efficiently but also securely and in compliance with the relevant regulatory standards.

In some embodiments, the facilitator 322, constructed as a software module, may be hosted on cloud infrastructure and programmed in a high-level language such as Java or Python. The alternate marketplace 324 could be implemented using blockchain technology to ensure transparency and security in the bidding process. The decentralized marketplace 402 might be a distributed ledger system, facilitating the registration and real-time interaction of various resource and non-resource applications. Bidding process 408 can be realized through smart contracts that automatically execute when predefined conditions are met, ensuring efficient and unbiased transaction allocation.

In other embodiments, the process is designed to be transparent to both the user and the bidder, providing valuable market insights. For the user, this transparency means access to information regarding their creditworthiness, and potentially, that of similar users in an anonymized fashion. It also includes visibility into current market rates and the terms received by other users with comparable financial standing. This feature enhances user trust and engagement by providing a clear picture of the financial landscape and where they stand within it. From a user interface perspective, implementing this process involves creating a user-friendly online dashboard or mobile application that provides users with transparent access to the decentralized market and their transaction routing options. In some embodiments, the application may be coded using web frameworks such as React or Angular for the frontend, with a backend potentially using Node.js or Python's Django framework to handle the server-side logic and database interactions.

In some embodiments, the frontend of the application or user interface may include interactive elements displaying the user creditworthiness and market rates. In some embodiments, creditworthiness may be visualized through a dashboard element like a gauge or scorecard, dynamically updated with data fetched from the backend services. In some embodiments, market rates and terms may be presented in a tabulated format or graphs, allowing users to compare their options easily. These elements may be populated in some embodiments by making API calls to the backend of the system, which would retrieve anonymized data from the decentralized marketplace, ensuring user anonymity. It is understood that the backend system may be tasked with the logic for fetching the relevant data, interfacing with the decentralized marketplace, and performing any necessary calculations or data processing. Smart contract interactions may be handled using web3.js or ethers.js libraries, which allow for seamless integration with blockchain-based systems like those running smart contracts. Regarding transactions, the backend may communicate with smart contracts deployed on the blockchain, sending and receiving transaction data. In some embodiments, this is presented to users through real-time notifications and updates on their dashboard, via a user device or web application, keeping them informed of their transaction status and the current market offers

Additionally, in some embodiments, the backend may employ the use machine learning algorithms to analyze market data and provide personalized insights to users, such as predicting creditworthiness changes or recommending the best time to enter the market. These algorithms would run on the server and be exposed to the frontend via RESTful APIs. To maintain a responsive and smooth user experience, asynchronous JavaScript (via async/await or promises, or the like) may be used to handle potentially long-running operations, such as waiting for blockchain confirmations, without blocking the UI. This ensures that the application remains responsive and informative, enhancing user trust and engagement.

In an exemplary embodiment of the present disclosure, a variety of machine learning algorithm techniques are utilized to analyze transaction data, providing actionable insights. For example, regression analysis, employing both linear and logistic models, is employed to predict continuous variables such as interest rates or to estimate the probability of discrete outcomes. These predictive models facilitate the anticipation of market trends and the assessment of security scoring with greater accuracy Further, classification algorithms, including but not limited to Support Vector Machines (SVM), Random Forest, and Gradient Boosting methods, are applied to categorize users into distinct creditworthiness tiers or to predict transaction viability. These sophisticated categorization techniques enable financial institutions to tailor their lending practices and assessments with enhanced precision.

Moreover, clustering algorithms, such as K-Means or Hierarchical Clustering, are employed to segment transactional data into clusters based on feature similarity, thereby enabling a nuanced understanding of market segments and consumer behavior patterns. Time series analysis is also utilized, applying models like ARIMA or LSTM networks, to scrutinize time-dependent data for trends and cyclic behaviors, which is of particular utility in the dynamic financial market landscape. Natural Language Processing (NLP) techniques, including sentiment analysis and topic modeling, are used to derive insights from textual data sources. This allows for the gauging of consumer sentiment or the detection of emergent market trends from qualitative data. Anomaly detection algorithms, such as Isolation Forest or One-Class SVM, serve a critical function in identifying atypical transaction patterns, contributing significantly to detection initiatives and systemic security management. Furthermore, the system may incorporate recommendation algorithms, utilizing collaborative filtering or content-based approaches, to personalize investment opportunities for lenders or to suggest financial products to consumers. Ensemble learning techniques, which combine multiple predictive models, enhance the accuracy of the provided insights. In more complex data scenarios, neural networks and deep learning models are trained to discern intricate patterns and make predictions based on large datasets, facilitating a breadth of tasks from identity verification processes to sophisticated market analyses. These machine learning models are continuously refined with incoming transaction data, ensuring that the insights they provide are both current and relevant. The outputs generated by these models are provided to third parties through well-defined APIs and user-friendly data dashboards, enabling these entities to make informed decisions, to assess security scores more accurately, and to deepen their understanding of the intricacies of market dynamics.

For bidders, such as financial institutions or individual lenders participating in the decentralized marketplace, this transparency serves to inform their bidding strategy. They gain insight into the nature of transactions they are underwriting, allowing them to tailor their bids more effectively. In some embodiments, the system may utilize smart contract protocols, which enable the automation of these bids and transactions, ensuring that they are executed promptly and accurately once agreed-upon conditions are met. The use of smart contracts also facilitates the creation of new rating systems that drive user engagement by allowing participants to be rated based on their transaction history and other factors within the network. This rating system encourages users to maintain a good standing and offers bidders additional criteria for making informed decisions.

Furthermore, the decentralized nature of this process enables the implementation of a peer-to-peer lending scheme. Here, users can obtain funding directly from their peers, bypassing traditional financial institutions. This not only has the potential to lower the cost of transaction processing due to the reduced overhead but also provides a more competitive lending environment. As such, users benefit from potentially lower rates, while lenders might enjoy higher returns on their underwritten transactions compared to conventional savings rates. In some embodiments, the decentralized lending scheme may be offered as an alternate route even when conventional application processing through financial institutions is available. This allows users to make an informed choice by comparing the rates offered by their financial institution with those available on the decentralized market. Such a feature empowers users to take control of their financial decisions, ensuring they have access to the most advantageous terms for their transactions, be it for obtaining loans or maximizing returns on investment. Through the interconnected operation of these components, FIG. 4 exemplifies a robust system designed to maintain operation continuity by intelligently navigating the complex landscape of decentralized exchange networks.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for operation continuity in decentralized exchange networks, the system comprising:
a processing device;
a non-transitory storage device containing instructions when executed by the processing device, causes the processing device to perform the steps of:
monitoring transaction requests received from one or more user devices;
detecting a disruption within a network affecting a transaction path of a specific transaction of the transaction requests;
identifying an alternate transaction path within the network in response to detecting the disruption;
rerouting the specific transaction to the alternate transaction path;
determining that the alternate transaction path is not available for the specific transaction;
submitting the specific transaction to a decentralized marketplace upon determining the alternate transaction path is not available for the specific transaction;
initiating a bidding process between one or more entities via the decentralized marketplace; and
providing a user interface via the one or more user devices displaying real-time transaction status and market data.

2. The system of claim 1, wherein the system is further configured to analyze historical transaction data to predict a future network disruption.

3. The system of claim 1, wherein the system is further configured to utilize machine learning algorithms to optimize the selection of the alternate transaction path.

4. The system of claim 1, wherein the system is further configured to utilize machine learning algorithms to aggregate and anonymize transaction data and provide market insights to one or more third-party entities.

5. The system of claim 1, wherein the system is further configured to dynamically update the user interface based on changes in the transaction status or market conditions.

6. The system of claim 1, wherein the system is further configured to generate and display, via the user interface, a comparison of transaction processing options between a traditional entity and the decentralized marketplace.

7. The system of claim 1, wherein the system is further configured to execute a smart contract automating the bidding process within the decentralized marketplace.

8. A computer program product for operation continuity in decentralized exchange networks, the computer program product comprising a non-transitory computer-readable medium comprising code causing an apparatus to:
monitoring transaction requests received from one or more user devices;
detecting a disruption within a network affecting a transaction path of a specific transaction of the transaction requests;
identifying an alternate transaction path within the network in response to detecting the disruption;
rerouting the specific transaction to the alternate transaction path;
determining that the alternate transaction path is not available for the specific transaction;
submitting the specific transaction to a decentralized marketplace upon determining the alternate transaction path is not available for the specific transaction;
initiating a bidding process between one or more entities via the decentralized marketplace; and
providing a user interface via the one or more user devices displaying real-time transaction status and market data.

9. The computer program product of claim 8, wherein the code further causes the apparatus to analyze historical transaction data to predict a future network disruption.

10. The computer program product of claim 8, wherein the code further causes the apparatus to utilize machine learning algorithms to optimize the selection of the alternate transaction path.

11. The computer program product of claim 8, wherein the code further causes the apparatus to utilize machine learning algorithms to aggregate and anonymize transaction data and provide market insights to one or more third-party entities.

12. The computer program product of claim 8, wherein the code further causes the apparatus to dynamically update the user interface based on changes in the transaction status or market conditions.

13. The computer program product of claim 8, wherein the code further causes the apparatus to generate and display, via the user interface, a comparison of transaction processing options between a traditional entity and the decentralized marketplace.

14. The computer program product of claim 8, wherein the code further causes the apparatus to execute a smart contract automating the bidding process within the decentralized marketplace.

15. A method for operation continuity in decentralized exchange networks, the method comprising:
monitoring transaction requests received from one or more user devices;
detecting a disruption within a network affecting a transaction path of a specific transaction of the transaction requests;
identifying an alternate transaction path within the network in response to detecting the disruption;
rerouting the specific transaction to the alternate transaction path;
determining that the alternate transaction path is not available for the specific transaction;
submitting the specific transaction to a decentralized marketplace upon determining the alternate transaction path is not available for the specific transaction;
initiating a bidding process between one or more entities via the decentralized marketplace; and
providing a user interface via the one or more user devices displaying real-time transaction status and market data.

16. The method of claim 15, wherein the method further comprises analyzing historical transaction data to predict a future network disruption.

17. The method of claim 15, wherein the method further comprises utilizing machine learning algorithms to optimize the selection of the alternate transaction path.

18. The method of claim 15, wherein the method further comprises utilizing machine learning algorithms to aggregate and anonymize transaction data and provide market insights to one or more third-party entities.

19. The method of claim 15, wherein the method further comprises dynamically updating the user interface based on changes in the transaction status or market conditions.

20. The method of claim 15, wherein the method further comprises generating and displaying, via the user interface, a comparison of transaction processing options between a traditional entity and the decentralized marketplace.
